(19) United States
(12) Patent Application Publication
(10) Pub. No.: US 2013/0285359 A1
(43) Pub. Date: Oct. 31, 2013

(54) Notebook Having Interchangeable Covers

(71) Applicant: SWITCHEE, INC., Encino, CA (US)

(72) Inventor: Owain Yeoman, Encino, CA (US)

(73) Assignee: Switchee, Inc., Encino, CA (US)

(21) Appl. No.: 13/871,590

(22) Filed: Apr. 26, 2013

Related U.S. Application Data
(60) Provisional application No. 61/639,431, filed on Apr. 27, 2012.

(51) Int. Cl. B42D 3/02

(52) U.S. Cl. CPC B42D 3/02
USPC 281/19.1; 150/165

(57) ABSTRACT

An apparatus and method for decorating a book, notebook or a mobile device with interchangeable decorative covers. The notebook cover has an area of ferrous metal. A corresponding decorative cover with a magnetic backing is configured to magnetically adhere to the ferrous metal.

### RELATED APPLICATIONS

This application claims the benefit of U.S. Provisional Patent Appl. Ser. No. 61/639,431 filed Apr. 27, 2012, the contents of which are incorporated by reference herein.

### FIELD OF THE INVENTION

The invention relates to the field of a stationary and notebooks, more specifically to a notebook having switchable covers.

### BACKGROUND OF THE INVENTION

Paper notebooks, scrapbooks or such similar pads are widely used across a wide spectrum of users. These include students at all levels as well as professionals and hobbyists. Conventional notebooks are typically provided with a standard cover that is usually bland, uninteresting and not personalizable. Moreover, notebooks are often used for long periods of time and once a notebook is selected for use, the user is stuck with the cover—without any possibility of changing it.

### SUMMARY OF THE INVENTION

The invention set forth herein relates to a novel notebook that is provided with a metallic surface on its cover. A cooperating decorative cover that is backed with magnetic material is designed to magnetically adhere to the metallic surface. This allows users to attach decorative covers of their own choosing and allows them to be replaced according to a user's preference.

### BRIEF DESCRIPTION OF THE DRAWINGS

FIG. 1 shows a top, perspective view of a notebook having a cover adapted to receive a magnetic sheet according to an embodiment of the invention.

FIG. 2 shows a top view of two decorative covers according to an embodiment of the invention.

FIG. 3 shows a top view of a notebook with a decorative cover adhered thereto according to an embodiment of the invention.

FIG. 4 shows a top, perspective view of a notebook having a cover adapted to receive a magnetic sheet according to an embodiment of the invention.

### DETAILED DESCRIPTION OF THE INVENTION

Embodiments of the present invention will now be described with reference to the above-identified Drawings. However, the Drawings and the description herein of the invention are not intended to limit the scope of the invention. It will be understood that various modifications of the present description of the invention are possible without departing from the spirit of the invention. Also, features described herein may be omitted, additional features may be included, and/or features described herein may be combined in a manner different from the specific combinations recited herein, all without departing from the spirit of the invention.

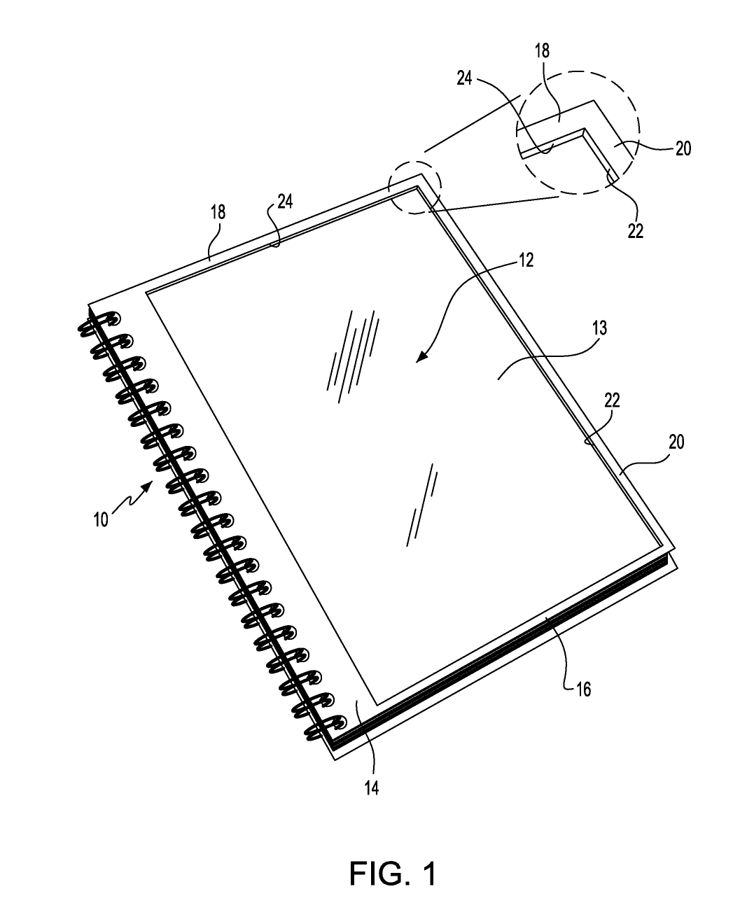

FIG. 1 shows a top view of a notebook according to an embodiment of the invention. In a preferred embodiment, the cover is formed of chipboard or such similar cardboard-like material, A sheet of ferrous metal is mounted to the notebook cover or coated thereon for the purpose of receiving a decorative cover having a magnetic backing. The material used on the notebook cover has an iron content of sufficient quantity to achieve a secure magnetic connection with a corresponding magnetic sheet. It will be understood by those of ordinary skill in the art that any of various metals or ferromagnetic substances, such as for example, iron, nickel, cobalt or alloys thereof may be used in embodiments of the invention (“ferrous material” herein shall mean any metal or alloy capable of attracting a magnet).

In one embodiment of the invention a ferrous metal sheet is permanently glued to a conventional chipboard notebook cover. In other embodiments of the invention, a ferrous metal layer encases a notebook cover from all sides. Alternatively, ferrous material may be coated atop of the notebook cover using any of various coating means known by those of ordinary skill in the art. It will be further understood that the ferrous material may be placed on a decorative cover and a corresponding magnetic surface may be placed on the notebook cover surface.

The notebook cover shown in FIG. 1 is designed to receive a decorative cover according to an embodiment of the invention. As shown, the notebook cover has a raised frame which surrounds a recessed area 12. Recessed area 12 has a bottom surface 13 upon which a magnetic sheet is placed. The frame surrounding recessed area 12 is made up of edges 14 and 20, which are substantially parallel to each other and edges 16 and 18 which are substantially parallel to each other. A side wall extending downward from each of the edges terminates on the bottom surface 13 of recessed area 12. In FIG. 1, inner frame walls 22 and 24 are shown extending downward from edges 20 and 16 respectively. (Walls that extend downward from the frame edges and terminate on bottom surface 13—e.g. walls 22 and 24—are alternatively referred to as “inner frame walls” herein.) The recessed area 12 is the space or slot defined by bottom surface 13 and the inner frame walls.

The bottom surface 13 of recessed area 12, or a portion thereof, is made of or contains ferrous material so as to attract a magnetic strip or sheet.

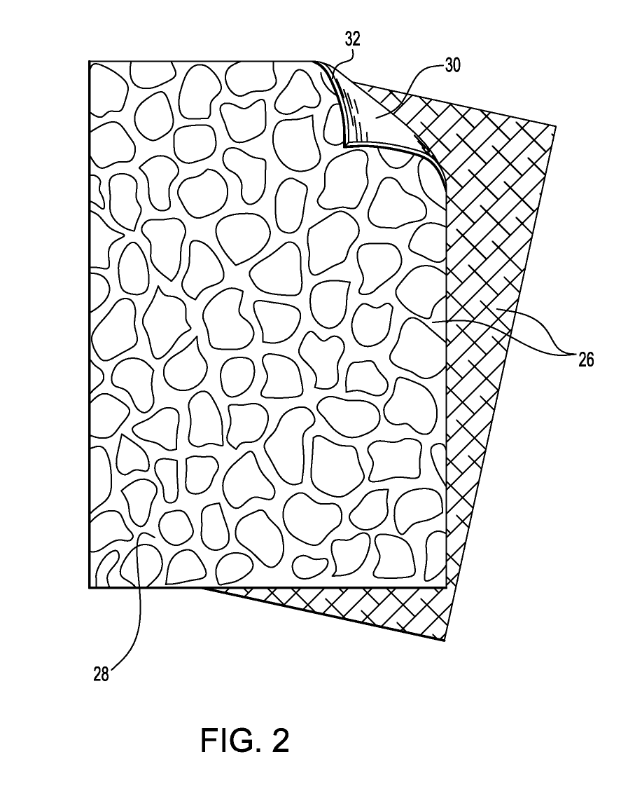

FIG. 2 shows two decorative covers 26 that may alternatively be inserted in recessed area 12 to decorate a notebook. As shown, decorative cover has a top surface 28 that is decorated with a design, pattern or other graphic content. The graphic sheet may be comprised of paper, card stock, plastic, vinyl or such similar bendable materials. In a preferred embodiment, the sheet carrying or imprinted with a design or other graphic content (“graphic sheet” herein) is glued to a magnetic sheet. In an embodiment of the invention a coating layer such as a plastic sealant is applied atop of the graphic sheet.

FIG. 2 shows a decorative cover with one of its corners bent back showing the magnetic sheet 30 or similar magnetic backing that lines the bottom surface thereof. It will be understood by those of ordinary skill in the art that any of various magnet configurations are possible. For example, a decorative cover may be backed with strips of magnets, or similar magnetic segments.

In a preferred embodiment, the decorative cover 26 has a thickness 32 that is substantially the same as the height of the inner frame walls, which extend downward from the edges to contact the bottom surface 13 of recessed area 12. As such, the thickness 32 of the decorative covers 26 substantially aligns with the height of the inner frame walls. In this manner, when a decorative cover 26 is seated in recessed area 12, the top surface 28 of the sheet 26 is substantially on the same plane and as edges 14, 16, 18 and 20. The edges 14, 16, 18 and 20 and top surface 28 of decorative cover 26 thereby form a substantially continuous surface.

In another embodiment of the invention, the decorative cover 26 has a thickness 32 that is greater than the height of the inner frame walls. As such, when a decorative cover is seated in the recessed area 12, the sheet protrudes slightly past edges 14, 16, 18 and 20 rather than being co-planar therewith. In this embodiment, a user may easily grasp the sheet and remove the same.

As shown, the decorative covers are preferably substantially rectangular in shape, having a length and a width. The outside contours of the decorative cover 26 is sized and shaped to fit within the rectangular area defined by the inner frame walls.

It will be understood by those of ordinary skill in the art, that a notebook may have more than one frame for receiving decorative covers. For example, rather than one rectangular recessed area for receiving a decorative cover, a notebook cover may have two or more smaller recessed areas or slots of varying shapes and sizes to accommodate various correspondingly sized and shaped decorative covers.

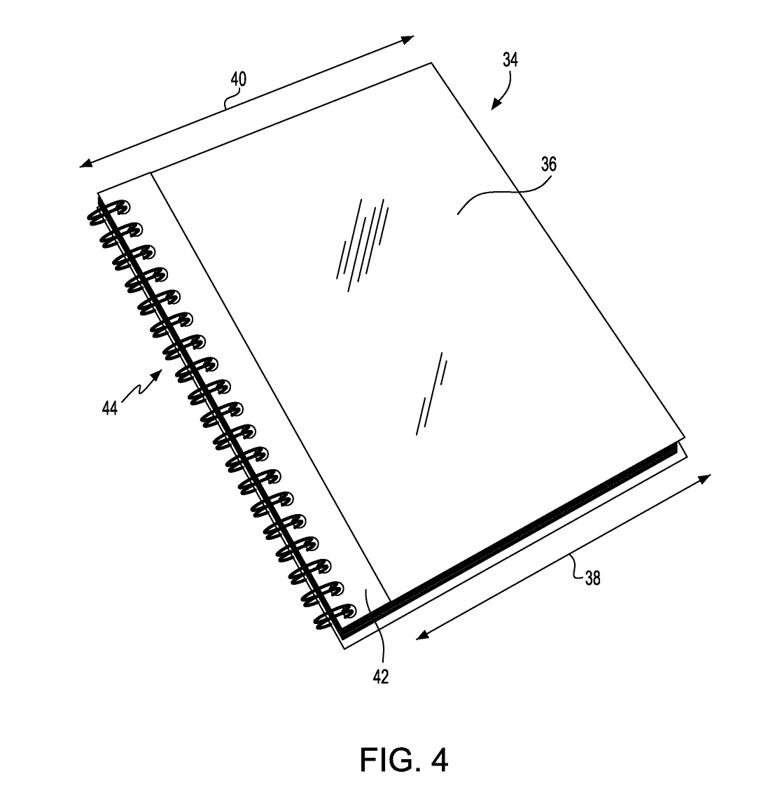

In other embodiments of the invention, a notebook cover is provided with a surface for receiving a decorative cover—without the need for a surrounding frame. For example, FIG. 4 shows a notebook having a cover having a metal plate or similar ferrous surface on its surface. As shown, a notebook 34 is shown having a ferrous surface 36 which has a length that is substantially the same as the notebook length and a width 38 that is somewhat less than the width 40 of the notebook cover. As shown, notebook 34 has a slender strip 42 of cover section that lies between the notebook binding 44 and the ferrous plate or surface 36. The ferrous surface extends outward from the edge of slender strip 42 and occupies the remainder of the notebook cover.

In a preferred embodiment, strip 42 is slightly elevated from the ferrous surface 36. That is, strip 42 has a wall extending downward therefrom which contacts the ferrous surface 36 (not shown). In a preferred embodiment, the height of the step down between strip 42 and ferrous surface 36 is substantially the same as the thickness 32 of a decorative cover 26. In this manner, when a decorative cover is seated on the ferrous surface, its top surface 28 will be substantially continuous or co-planar with the top surface of strip 42. In other embodiments, the step down between strip 42 and surface 36 may be slightly greater than or less than the thickness 32 of a decorative cover.

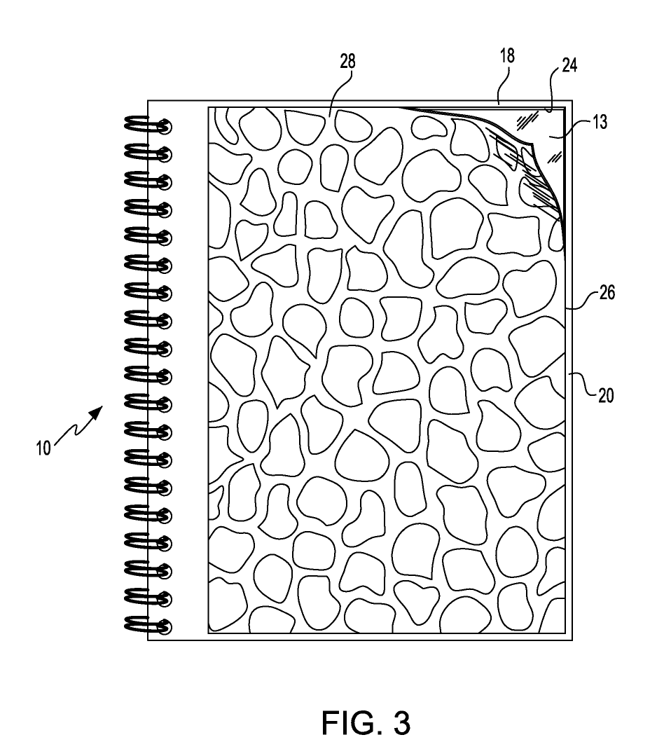

FIG. 3 shows a notebook 10 with a decorative cover 26 applied thereto. As shown, the decorative cover occupies roughly the entirety of the metal plate and it conveys a beautiful and stylish appearance. FIG. 3 shows the top, right edge of the decorative cover 26 being lifted up. To remove a decorative cover 26, a user need only grasp a corner of the sheet and pull it upward—thereby removing the same.

It will be understood by those of ordinary skill in the art that in different embodiments of the invention, a front cover of a book could be made entirely of metal material. A corresponding decorative cover may be applied thereto.

It will be further understood, that the inventive method and apparatus for allowing for switchable decorative covers could be used for any type of book and/or mobile device and it is not limited to use with notebooks. For example, decorative covers may be designed to adhere to corresponding ferrous surfaces on mobile devices, such as for example, Apple's iPhone®, iPad® and other mobile phones and tablet computers. The invention, relates to any device having a metallic surface that is sized and shaped to securely adhere a corresponding interchangeable magnetic sheet.

Having described this invention with regard to specific embodiments, it is to be understood that the description is not meant as a limitation since further modifications and variations may be apparent or may suggest themselves to those skilled in the art. It is intended that the present application cover all such modifications and variations.

What is claimed is:

1. An apparatus for interchangeable cover designs, comprising:
a book cover comprising a top surface,
an area on said top surface of said book cover comprising ferrous material;
a decorative cover, said decorative cover comprising a graphic sheet, said graphics sheet having a magnetic backing;
said decorative cover being sized to fit on said area on said top surface of said book cover comprising ferrous material;
whereby when said decorative cover is placed on said area comprising ferrous material, said magnetic backing adheres to said ferrous material, thereby securing said decorative cover to said book cover.

2. The apparatus of claim 1, whereby said book cover comprises a recessed area, said recessed area comprising a bottom surface and surrounding inner walls.

3. The apparatus of claim 1, whereby said bottom surface comprises ferrous metal.

4. The apparatus of claim 2, whereby said decorative cover is sized and shaped to fit within said recessed area.

5. The apparatus of claim 1, whereby said book cover comprises a strip of non-ferrous material and an area having ferrous material extending therefrom.

6. The apparatus of claim 1, whereby said book cover is comprised of ferrous material.

7. The apparatus of claim 1, whereby said top surface of said book cover comprises a plurality of slots, each of said slots being adapted to receive a decorative cover.

8. The apparatus of claim 1, whereby said magnetic backing on said decorative cover comprises a magnetic sheet.

9. The apparatus of claim 1, whereby said magnetic backing on said decorative cover comprises magnetic strips.

10. An apparatus for interchangeable cover designs, comprising:
a mobile device comprising a top surface,
an area on said top surface of said mobile device comprising ferrous material;
a decorative cover, said decorative cover comprising a graphic sheet, said graphic sheet having a magnetic backing;
said decorative cover being sized to fit on said area on said top surface of said mobile device comprising ferrous material;
whereby when said decorative cover is placed on said area comprising ferrous material, said magnetic backing adheres to said ferrous material, thereby securing said decorative cover to said mobile device.

11. The apparatus of claim 10, whereby said mobile device comprises a mobile phone or a mobile tablet computer.
